(19) United States
(12) Patent Application Publication
(10) Pub. No.: US 2019/0075828 A1
(43) Pub. Date: Mar. 14, 2019

(54) Method for Reducing Oil Content of Fried Potato Chips

(71) Applicants: Liuping Fan, Wuxi (CN); Bo Jia, Wuxi (CN); Jinwei Li, Wuxi (CN)

(72) Inventors: Liuping Fan, Wuxi (CN); Bo Jia, Wuxi (CN); Jinwei Li, Wuxi (CN)

(73) Assignee: Jiangnan University, Wuxi (CN)

(21) Appl. No.: 16/185,016

(22) Filed: Nov. 9, 2018

Related U.S. Application Data
(63) Continuation of application No. PCT/CN2017/113160, filed on Nov. 27, 2017.

(30) Foreign Application Priority Data
Jan. 19, 2017 (CN) 2017100437021

(51) Int. Cl. A23L 19/18; A23B 7/06; A23P 20/10; A23L 5/10

(52) U.S. Cl. CPC A23L 19/18; A23B 7/06; A23V 2002/00; A23L 5/11; A23P 20/105

(57) ABSTRACT

Disclosed is a method for reducing the oil content of fried potato chips. According to the method, potatoes are used as raw materials, which are washed, peeled and cut into chips and are subjected to an ion blanching. The potato chips are then coated with a mixed solution of guar gum and sorbitol, and the potato chips are fried after coating. Calcium ions in blanching liquid can chemically react with low-methoxyl pectin contained in the potato chips to form a bridged structure. The calcium ions may also interact with guar gum to facilitate the escape of moisture and reduce the entry of oil during the frying process. Addition of sorbitol can further improve the structure of the coating membrane of guar gum to effectively reduce the oil content without significant influence on the moisture content and other qualities of the final products.

### CROSS-REFERENCES AND RELATED APPLICATIONS

This application is a continuation of PCT application No. PCT/CN2017/113160, filed Nov. 27, 2017, which claims the benefit of priority to Chinese Application No. 2017100437021, entitled “A Method for Reducing Oil Content of Fried Potato Chips”, filed Jan. 19, 2017, which is herein incorporated by reference in its entirety.

### BACKGROUND OF THE INVENTION

### Field of the Invention

The present application relates to a method for reducing the oil content of fried potato chips, and belongs to the technical field of deep processing of food.

### Description of the Related Art

The scientific name of potatoes is Solanum tuberosum, which belongs to herbaceous perennials of Solanaceae. The potatoes contain rich vitamin A, vitamin B1 (thiamine), vitamin B2 (riboflavin), vitamin pp (niacin), vitamin E (tocopherol), and B-vitamins such as pantothenic acid as well as plenty of high-quality cellulose, and further contain trace elements, amino acids, protein, fat, high-quality starch and other nutrient elements. The potatoes were native to the Andes areas of South America and were taken as main food by the American Indians very early. In the late Ming dynasty, the potatoes were transported to China and Japan by Dutch ships and were quickly spread there. The main potato producing areas in China are the southwest mountainous area, northwest China, Inner Mongolia and northeast China.

As a kind of leisure food, potato chips are deeply loved by people due to their unique taste and flavor. The sale volume of the potato chips is increasing day by day and the photo chips account for a large share of the leisure foods. Improving the deep processing technology of potatoes is important to increase the added value of Chinese potatoes and accelerate the economic development of potato producing areas. Fried foods are popular among consumers at home and abroad. However, the potato chips obtained in a traditional fried manner are high in oil content. The long-term consumption of fried potato chips is bad for health and may easily cause diseases such as obesity, high blood pressure and high cholesterol. Therefore, there is a need for developing methods to minimize the oil content of fried potato chips. The common methods for reducing the oil content in fried potato chips include a processing method, a pre-drying method and a coating method.

The processing method is the most common method for reducing the oil content of fried potato chips. It is achieved by optimizing processing parameters such as frying temperature and frying time in a frying process. However, the oil content reduced by this method is very limited, and the optimization of processing parameters is also complicated and not fixed. According to the pre-drying method, some drying equipment is used for removing moisture of raw materials before the frying is performed so that the oil content can be reduced well to some degree. But the pre-drying equipment is relatively expensive and complicated in operation.

The coating method is used for adding a layer of edible coating to the surface of raw potatoes. The coating material can reduce the surface tension of the raw materials, and is a good oxygen, carbon dioxide and oil blocking agent, which can make the surfaces of fried products to be relatively smooth and reduce the breakage of the surfaces of the raw materials and regeneration of pores. Hydrogen bonds are formed between the coating material and polymers can increase the elongation of the coating, which better reduces the oil content.

The research from A. H. Khalil (1999) finds that addition of calcium ions can reduce the oil content of fried potato chips. The oil reducing effect initially increases with the increasing amount of calcium ions and eventually levels off at higher concentration of calcium. Combination of calcium ions and pectin forms a chemical gel that can further decrease the oil content of potato chips. 0.5% of calcium chloride and 5% of pectin is found to have the best oil reducing effect. But the contribution of ion-blanching to the reduction of the final moisture content of coated fried potato chips was not reported by him.

The research from Rimac-Brncic et al. (2004) finds that the best oil reducing effect was achieved when 0.5% of calcium chloride was used for blanching and 1% of CMC (carboxymethylcellulose) was used for coating. The results show that the combination of ionic blanching processing and a coating technology has a better oil reducing effect.

A. Daraei Garmakhany et al. (2014) studied the influence of different coating materials and multiple layers of coatings on the oil content of potato chips. There were significant differences between samples coated with 1% of guar gum, pectin and xanthan gum and the control group in terms of the final moisture content. The moisture content of the fried samples after coating was obviously higher than that of the control group, which indicates that the coatings reduce the oil content of the fried samples, but hinder the escape of moisture in the samples.

Xanthan gum, guar gum, sodium alginate and the like are commonly-used coating agents. But the oil reducing rate of a single coating agent is not obvious, usually in the range of 20%-30%. In addition, the final moisture content of the coated potato chips is high. Therefore, there is a need for developing methods that can effectively reduce the oil content of potato chips without increasing the moisture content or affecting other qualities of the final product.

### SUMMARY OF THE INVENTION

The invention aims at providing a method for preparing fried potato chips with low oil content, which effectively reduces the oil content of products without obvious influence on other qualities of the products.

In one embodiment of the present invention, potatoes are used as raw materials, an ion solution is used for blanching, a guar gum and sorbitol mixed solution is used as a coating agent, and afterwards, frying is performed.

The technical scheme of the present invention comprises the following steps of:

(1) treatment of raw materials: washing fresh potatoes thoroughly, peeling the potatoes, and cutting the potatoes into uniform potato chips;

(2) blanching: transferring the uniform potato chips in step (1) to a 0.3%-0.7% (g/100 mL) calcium ion solution for blanching, and blanching for 3-6 minutes at the temperature of 80-95° C. so as to destruct enzyme activity and prevent enzymatic browning;

(3) coating: transferring the blanched potato chips in step (2) to a mixed solution containing 0.8%-1.2% (w/w) of guar gum and 1%-5% (w/w) of sorbitol, and coating the potato chips for 2-5 minutes at the temperature of 38-45° C.; and

(4) frying: frying the coated potato chips at normal atmospheric pressure and the temperature of 160-190° C. for 2-7 minutes to obtain the fried potato chips with the moisture content being 48%-67% and the oil content being 17%-25%.

In one embodiment of the present invention, the fresh potatoes are washed thoroughly, peeled and cut into uniform 7*7*60 mm or 8*8*60 mm or 10*10*60 mm potato chips.

In one embodiment of the present invention, the blanching liquid is a 5% ion solution, and the coating agent comprises 1% of guar gum and 3% of sorbitol.

In one embodiment of the present invention, the blanching is performed for 4 minutes at the temperature of 95° C.

In one embodiment of the present invention, the coating is performed for 3 minutes at the temperature of 40° C.

In one embodiment of the present invention, the frying is performed for 3 minutes at the temperature of 170° C.

The method for preparing fried potato chips comprises the steps of washing, peeling, cutting, ion blanching, coating with a mixed solution of guar gum and sorbitol, and finally frying the potato chips. Calcium ions in blanching liquid can chemically react with low-methoxyl pectin contained in the potato chips to form a bridged structure. The calcium ions may also interact with guar gum to facilitate the escape of moisture and reduce the entry of oil during the frying process. As high-temperature frying causes pores to be formed in the guar gum coating, oil can enter potato chips through the pores. Addition of sorbitol can further improve the structure of the coating membrane to effectively reduce the oil content without significant influence on the moisture content and other qualities of the final products. After being coated with the mixed solution of guar gum and sorbitol, the potato chips have relatively good stability in a freezing storage process, and still have relatively good oil reducing effect after long-term freezing storage.

### DETAILED DESCRIPTION

The technical details of some embodiments of the present invention are further described and illustrated below with reference to the accompanying drawings in the following examples. The examples are described only for illustration purpose, not to limit the scope of the present invention which is defined by the claims hereafter.

### Example 1

Ion blanching+guar gum+sorbitol group: the potatoes were washed, peeled and cut into uniform 8*8*60 mm potato chips and the potato chips were blanched for 4 minutes in a 0.5% (g/100 mL) calcium ion solution at the temperature of 95° C. After being blanched, the potato chips were put in a cold bath, and the samples were taken out so as to remove excessive moisture on the surfaces, transferred to a mixed solution of 1% guar gum and 3% sorbitol, and coated for 3 minutes at the temperature of 45° C. The coated samples were cooled to room temperature, and fried for 3 minutes at the temperature of 170° C.

Control group: the potatoes were washed, peeled and cut into uniform 8*8*60 mm potato chips; the potato chips were blanched for 4 minutes in 95° C. water. After being blanched, the potato chips were put in a cold bath, and the samples were taken out so as to remove excessive moisture on the surfaces and fried for 3 minutes at the temperature of 170° C.

Ion blanching group: the potatoes were washed, peeled and cut into uniform 8*8*60 mm potato chips, and the potato chips were blanched for 4 minutes in a 0.5% calcium ion solution at the temperature of 95° C. After being blanched, the potato chips were put in a cold bath, and the samples were taken out to remove excessive moisture on the surfaces and fried for 3 minutes at the temperature of 170° C.

1% guar gum group: the potatoes were washed, peeled and cut into uniform 8*8*60 mm potato chips, and the potato chips were put in a 1% guar gum solution and coated for 3 minutes at the temperature of 45° C. The coated samples were cooled to room temperature and fried for 3 minutes at the temperature of 170° C.

Ion blanching+guar gum group: the potatoes were washed, peeled and cut into uniform 8*8*60 mm potato chips, and the potato chips were blanched for 4 minutes in a 0.5% calcium ion solution at the temperature of 95° C. After being blanched, the potato chips were put in a cold bath; and the samples were taken out to remove excessive moisture on the surfaces, transferred to a 1% guar gum solution, and coated for 3 minutes at the temperature of 45° C. The coated samples were cooled to room temperature and fried for 3 minutes at the temperature of 170° C.

Ion blanching+guar gum+glycerinum group: the potatoes were washed, peeled and cut into uniform 8*8*60 mm potato chips; and the potato chips were blanched for 4 minutes in a 0.5% calcium ion solution at the temperature of 95° C. After being blanched, the potato chips were put in cold bath, and the samples were taken out to remove excessive moisture on the surfaces, transferred to the mixed solution of 1% guar gum and 3% glycerinum, and coated for 3 minutes at the temperature of 45° C. The coated samples were cooled to room temperature and fried for 3 minutes at the temperature of 170° C.

After the fried samples were dried to a constant temperature, the fat content of the fried samples was measured by a fat analyzer. As shown in tables 1 and 2, the ion blanching can significantly reduce the total oil content and final moisture content (p<0.05) of the samples. The ion blanching+guar gum+sorbitol composite processing can significantly reduce the total oil content of the products and does not affect the moisture content of the final products.

TABLE 1
The influence of ion blanching performed in a 0.5% calcium
ion solution on the final moisture content, total oil
content and texture of the fried potato chips

| | Final moisture | Total oil | | |
|---|---|---|---|---|
| | content | content | | |
| Samples | (%, wet basis) | (%, dry basis) | Hardness | Chewiness |
| Control | 65.53 ± 1.71^{a} | 32.73 ± 1.12^{a} | 540 ± 43.2^{a} | 14.8 ± 0.20^{a} |
| group | | | | |
| Ion | 61.47 ± 1.38^{b} | 27.56 ± 1.32^{b} | 615 ± 8.94^{a} | 48.6 ± 3.11^{b} |
| blanching | | | | |
| group | | | | |

TABLE 2
The influence before and after ion blanching and
the influence of coating on the moisture content
and oil content of the fried potato chips

| | Final moisture content | Total oil content |
|---|---|---|
| Samples | (%, wet basis) | (%, dry basis) |
| Control group | 65.53 ± 1.71^{b} | 32.73 ± 1.12^{a} |
| 1% guar gum group | 68.40 ± 0.97^{a} | 24.12 ± 0.97^{b} |
| Ion blanching + | 63.17 ± 0.08^{c} | 24.76 ± 0.25^{b} |
| guar gum group | | |
| Ion blanching + | 66.41 ± 1.34^{b} | 22.82 ± 1.83^{c} |
| guar gum + | | |
| glycerinum group | | |
| Ion blanching + | 65.18 ± 1.42^{b} | 17.82 ± 1.29^{d} |
| guar gum + | | |
| sorbitol group | | |

The “a, b, c, d” letters are used to denote levels of significant difference in different groups where the groups denoted with the same letter are not significantly different from each other and the groups denoted with different letters are significantly different from each other.

### Example 2

The potatoes were washed, peeled and cut into uniform 8*8*60 mm potato chips, and the potato chips were blanched for 4 minutes in a 0.5% calcium ion solution at the temperature of 95° C. After being blanched, the potato chips were put in a cold bath, and the samples were taken out to remove excessive moisture on the surfaces, transferred to a mixed solution of 1% guar gum and 3% sorbitol, and coated for 4 minutes at the temperature of 40° C. The coated samples were cooled to room temperature and fried for 6 minutes at the temperature of 170° C. After the fried samples were dried to a constant temperature, the fat content of the fried samples was measured by the fat analyzer.

The final moisture content of the samples is 58.96±2.82%, and the total oil content is 21.5±1.32%. Compared to the “Ion blanching+guar gum+sorbitol” group of Example 1, the Example 2 increased the frying time is by 3 minutes. The moisture content of the final product was reduced, and the total oil content was increased in Example 2. Compared to the control group of the Example 1, the Example 2 has the effect of reducing the total oil content by 34%. The high-temperature long-time frying, though increases the total oil content, does not destroy the oil reducing ability of the guar gum/sorbitol coating solution.

### Example 3

The potatoes were washed, peeled and cut into uniform 8*8*60 mm potato chips, and the potato chips were blanched for 4 minutes in a 0.5% calcium ion solution at the temperature of 95° C. After being blanched, the potato chips were put in a cold bath and the samples were taken out to remove excessive moisture on the surfaces, transferred to the mixed solution of 1% guar gum and 3% sorbitol, and coated for 5 minutes at the temperature of 45° C. The coated samples were cooled to room temperature and fried for 3 minutes at the temperature of 170° C.

After the fried samples were dried to a constant temperature, the fat content of the fried samples was measured by the fat analyzer. The final moisture content of the samples was 65.25±0.35%, and the total oil content was 19.79±1.65%. Compared to the Examples 1, the Example 3 increased the coating time by 2 minutes. After the products were fried, there was no significant change in the moisture content and total oil content, further indicating the relative good stability and applicability of the composite coating solution of guar gum and sorbitol.

### Example 4

The potatoes were washed, peeled and cut into uniform 8*8*60 mm potato chips, and the potato chips were blanched for 4 minutes in a 0.7% calcium ion solution at the temperature of 95° C. After being blanched, the potato chips were put in a cold bath, and the samples were taken out to remove excessive moisture on the surfaces, transferred to the mixed solution of 1% guar gum and 6% sorbitol, and coated for 5 minutes at the temperature of 50° C. The coated samples were cooled to room temperature and fried for 3 minutes at the temperature of 170° C.

After the fried samples were dried to a constant temperature, the fat content of the fried samples was measured by the fat analyzer. The final moisture content of the samples was 67.25±0.25%, and the total oil content was 20.79±1.35%. Compared with the Examples 1, the Example 4 increased the coating temperature and the concentration of sorbitol, and the water-retaining property of the composite coating solution was improved, leading to slight increase of the moisture content and improved tenderness of the interior of the fried potato chips.

### Example 5

The potatoes were washed, peeled and cut into uniform 8*8*60 mm potato chips, and the potato chips were blanched for 4 minutes in a 0.5% calcium ion solution at the temperature of 95° C. After being blanched, the potato chips were put in a cold bath, and the samples were taken out to remove excessive moisture on the surfaces, transferred to the mixed solution of 1% guar gum and 3% sorbitol, and coated for 3 minutes at the temperature of 45° C. The coated samples were cooled to room temperature, frozen for 12 months at the temperature of −20° C. and fried for 3 minutes at the temperature of 170° C.

After the fried samples were dried to a constant temperature, the fat content of the fried samples was measured by the fat analyzer. The final moisture content of the samples was 48.58±1.08%, and the total oil content is 15.67±0.14%. There was no significant change in hardness, chewiness and color of the products. Compared with the Examples 1, the Example 5 added a freezing process. After the products are fried, the moisture content and total oil content of the products were significantly reduced, and the texture and color of the products remained unchanged, indicating that the composite coating formula has relatively good stability under a long-term freezing condition, and the formed coating still has a good oil reducing ability.

What is claimed is:

1. A method for preparing fried potato chips, comprising using a calcium ion solution for blanching, and a mixed solution of guar gum and sorbitol as a coating agent.

2. The method of claim 1, comprising the steps of:
1) washing fresh potatoes thoroughly, peeling the potatoes, and cutting the potatoes into uniform potato chips;
2) blanching the potato chips by transferring them to a 0.3%-0.7% calcium ion solution, and incubating for 3-6 minutes at a temperature of 80-95° C.;
3) coating the blanched potato chips in step (2) with a mixed solution containing 0.8%-1.2% of guar gum and 1%-5% of sorbitol by mass percentage, and incubating for 2-5 minutes at a temperature of 38-45° C.; and
4) frying the coated potato chips at normal atmospheric pressure and a temperature of 160-190° C. for 2-7 minutes.

3. The method of claim 2, wherein the potatoes are cut into uniform 7*7*60 mm or 8*8*60 mm or 10*10*60 mm potato chips.

4. The method of claim 2, wherein the uniform potato chips are transferred to a 0.5% calcium ion solution for blanching.

5. The method of claim 2, wherein the blanching is performed for 4 min, at 95° C.

6. The method of claim 2, wherein guar gum and sorbitol in the mixed solution are 1% and 3% by mass percentage, respectively.

7. The method of claim 2, wherein the coating is performed for 3 min, at 40° C.

8. The method of claim 2, wherein the frying is performed for 3 min, at 170° C.

9. The potato chips prepared by the method of claim 1.
